(19) United States
(12) Patent Application Publication
(10) Pub. No.: US 2005/0006361 A1
(43) Pub. Date: Jan. 13, 2005

(54) Machining apparatus utilizing laser beam

(76) Inventors: Satoshi Kobayashi, Tokyo (JP); Yusuke Nagai, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/885,311

(22) Filed: Jul. 7, 2004

(30) Foreign Application Priority Data
Jul. 11, 2003 (JP) 2003-273341

(51) Int. Cl. B23K 26/06

(52) U.S. Cl. 219/121.73; 219/121.74; 219/121.75

(57) ABSTRACT

A machining apparatus utilizing a laser beam, the machining apparatus being capable of efficiently forming a deterioration zone of a required thickness along a division line. A laser beam from laser beam generation means is focused not to a single focused spot, but to at least two focused spots displaced in the direction of an optical axis.

### FIELD OF THE INVENTION

This invention relates to a machining apparatus utilizing a laser beam and, more particularly, to a machining apparatus comprising holding means for holding a workpiece, laser beam generation means, and optical means for applying a laser beam from the laser beam generation means to the workpiece.

### DESCRIPTION OF THE PRIOR ART

It is well known, for example, in the production of a semiconductor device that many semiconductor circuits are formed on the face of a wafer including a substrate, such as a silicon substrate, a sapphire substrate, a silicon carbide substrate, a lithium tantalate substrate, a glass substrate, or a quartz substrate, and then the wafer is divided to form the individual semiconductor circuits. Various methods utilizing a laser beam have been proposed for dividing the wafer.

U.S. Pat. No. 6,211,488 and Japanese Patent Application Laid-Open No. 2001-277163 each disclose a wafer dividing method which comprises focusing a laser beam onto an intermediate portion in the thickness direction of a wafer, relatively moving the laser beam and the wafer along a division line, thereby forming a deterioration zone along the division line in the intermediate portion in the thickness direction of the wafer, and then exerting an external force on the wafer to break the wafer along the deterioration zone.

The methods of dividing the wafer are not limited to the formation of the deterioration zone in the intermediate portion in the thickness direction of the wafer. It is also conceivable to form the deterioration zone along the division line in a region ranging from the back of the wafer to a depth of a predetermined thickness, or in a region ranging from the face of the wafer to a predetermined depth. In any of these cases, sufficiently precise breakage along the division line by exerting an external force on the wafer requires that the thickness of the deterioration zone, namely, the dimension of the deterioration zone in the thickness direction of the wafer, be rendered relatively large. Under certain circumstances, the deterioration zone needs to cover the entire thickness of the wafer. To increase the thickness of the deterioration zone, it is necessary to displace the position of the focused spot of the laser beam in the thickness direction of the wafer and repeatedly move the laser beam and the wafer relative to each other along the division line, because the deterioration zone is formed in the vicinity of the focused spot of the laser beam. Particularly when the thickness of the wafer is relatively large, therefore, a relatively long time is taken for forming the deterioration zone of a necessary thickness to break the wafer sufficiently precisely.

### SUMMARY OF THE INVENTION

A principal object of the present invention is to provide a novel and improved machining apparatus utilizing a laser beam, the apparatus being capable of efficiently forming a deterioration zone of a required thickness along a division line.

According to the present invention, the principal object is attained by focusing a laser beam from laser beam generation means not to a single focused spot, but to at least two focused spots displaced in the direction of an optical axis.

That is, according to the present invention, as a machining apparatus utilizing a laser beam, aimed at attaining the above-described principal object, there is provided a machining apparatus utilizing a laser beam, which comprises holding means for holding a workpiece, laser beam generation means, and optical means for applying a laser beam from the laser beam generation means to the workpiece held by the holding means, and which is characterized in that the optical means focuses the laser beam from the laser beam generation means to at least two focused spots displaced in the direction of an optical axis.

In a preferred embodiment, the optical means includes at least two focusing lenses arranged in column in the direction of the optical axis and having different apertures. In another preferred embodiment, the optical means includes a splitter for separating the laser beam from the laser beam generation means into a first laser beam and a second laser beam; a plurality of mirrors for bringing the optical axis of the second laser beam into conformity with the optical axis of the first laser beam; diameter varying means for varying one of the diameters of the first laser beam and the second laser beam; and a common focusing lens. The diameter varying means preferably can adjust the degree to which the diameter is varied. The diameter varying means may be an expander for increasing the diameter.

In the machining apparatus of the present invention, the laser beam from the laser beam generation means is focused to at least two focused spots displaced in the direction of the optical axis. Thus, deterioration zones can be simultaneously formed in at least two regions displaced in the thickness direction of the workpiece. Consequently, deterioration zones of a required thickness can be formed sufficiently efficiently.

### BRIEF DESCRIPTION OF THE DRAWINGS

FIG. 1 is a schematic view showing a first embodiment of a machining apparatus constructed in accordance with the present invention.

FIG. 2 is a schematic view showing a second embodiment of a machining apparatus constructed in accordance with the present invention.

FIG. 3 is a schematic view showing a third embodiment of a machining apparatus constructed in accordance with the present invention.

### DETAILED DESCRIPTION OF THE PREFERRED EMBODIMENTS

Preferred embodiments of the machining apparatus constructed in accordance with the present invention will now be described in greater detail by reference to the accompanying drawings.

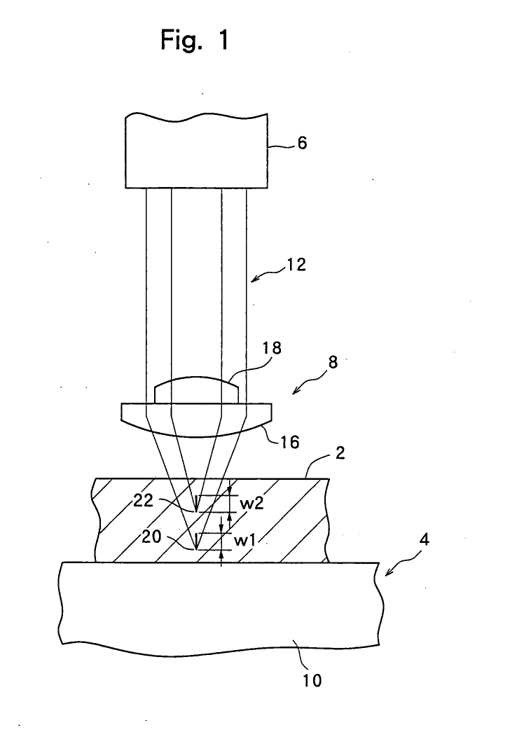

FIG. 1 schematically shows a first embodiment of a machining apparatus constructed in accordance with the present invention. The illustrated machining apparatus comprises holding means 4 for holding a workpiece 2, laser beam generation means 6, and optical means 8.

The holding means 4 is composed of, for example, a holding member 10, which is a porous member or a member having a plurality of suction holes and/or suction grooves, and suction means (not shown) annexed to the holding member 10. The holding means 4 may be of a type attracting the workpiece 2, for example, a wafer, to the surface of the holding member 10 by suction.

It is important for the laser beam generation means 6 to be one generating a laser beam capable of passing through the workpiece 2. If the workpiece 2 is a wafer including a substrate, such as a silicon substrate, a sapphire substrate, a silicon carbide substrate, a lithium tantalate substrate, a glass substrate, or a quartz substrate, the laser beam generation means 6 can advantageously be composed of a YVO4 pulse laser or YAG pulse laser which generates a laser beam having a wavelength of, for example, 1064 nm. In the illustrated embodiment, the laser beam generation means 6 emits a pulse laser beam 12 toward the workpiece 2 held on the holding means 4.

The optical means 8, interposed between the laser beam generation means 6 and the workpiece 2, is composed of two focusing lenses 16 and 18 placed in column in the direction of an optical axis. The aperture of the focusing lens 16 is relatively large, while the aperture of the focusing lens 18 is relatively small. The lower surface of the focusing lens 16 is downwardly convex, and its upper surface is a flat surface. The lower surface of the focusing lens 18 is a flat surface, and its upper surface is upwardly convex. The lower surface of the focusing lens 18 is superposed on the upper surface of the focusing lens 16. If desired, the focusing lens 16 and the focusing lens 18 can be formed integrally.

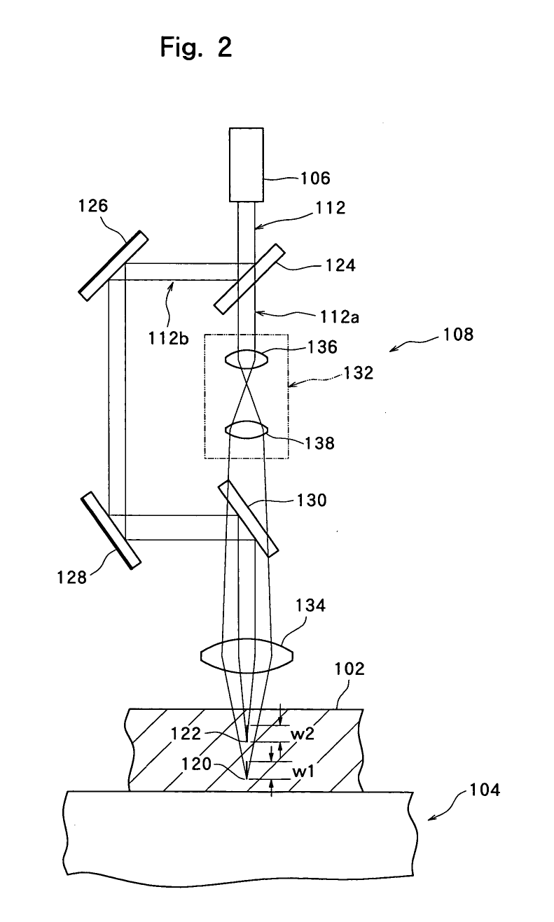

In the above-described machining apparatus, the laser beam 12 from the laser beam generation means 6 is focused to two focused spots 20 and 22, which are displaced in the direction of the optical axis in the workpiece 2, by the optical focusing action of the optical means 8 composed of the two focusing lenses 16 and 18. In further detail, part of the laser beam 12, namely, its diametrically peripheral edge portion, passes through the focusing lens 16 alone, and is then focused to the focused spot 20 in the workpiece 2. The remainder of the laser beam 12, namely, its diametrically central portion, passes through the focusing lens 16 along with the focusing lens 18, and is then focused to the focused spot 22 in the workpiece 2. The focused spot 20 and the focused spot 22 are displaced from each other in the direction of the optical axis of the laser beam 12. When the laser beam 12 is focused to the focused spots 20 and 22, deterioration zones are formed in the workpiece 2 in the vicinity of the focused spots 20 and 22, normally, in regions having certain widths, width W1 and width W2, measured upwardly from the focused spots 20 and 22. The width W1 and the width W2 may be substantially the same, or may be different from each other. The deterioration zone of the width W1 and the deterioration zone of the width W2 may be formed with spacing in the thickness direction of the workpiece 2, as clearly shown in FIG. 2, or may be formed substantially continuously in the thickness direction of the workpiece 2. Deterioration in the deterioration zone depends on the material for the workpiece 2 and the intensity of the laser beam 12 focused. Normally, the deterioration is melting/resolidification (namely, melting taking place when the laser beam 12 is focused, followed by solidification occurring after the focusing of the laser beam 12 is completed), voids, or cracks. Hence, when the combination of the laser beam generation means 6 and the optical means 8, and the holding means 4 are relatively moved along a division line extending, for example, in the right-and-left direction in FIG. 1, there are formed, in the workpiece 2, two deterioration zones extending continuously with the width W1 and the width W2 along the division line (if the spots constituting the focused spots 20 and 22 of the laser beam 12, the spots adjacent in the direction of the relative movement, partially overlap), or many deterioration zones of the width W1 and the width W2 located at intervals along the division line (if the spots constituting the focused spots of the laser beam 12, the spots adjacent in the direction of the relative movement, are located at intervals). That is, according to the first embodiment constituted in accordance with the present invention, the deterioration zones of the width W1 and the width W2 can be formed simultaneously, by the single laser beam generation means 6, in two regions displaced in the thickness direction of the workpiece 2.

If the deterioration zones of the width W1 and the width W2 are not enough to divide the workpiece 2 sufficiently precisely along the division line, it is permissible to take the following measure: The combination of the laser beam generation means 6 and the optical means 8, and the holding means 4 are relatively moved by a predetermined distance in the direction of the optical axis, namely, in the up-and-down direction in FIG. 1, whereby the focused spots 20 and 22 are displaced in the direction of the optical axis, accordingly in the thickness direction of the workpiece 2. Furthermore, the combination of the laser beam generation means 6 and the optical means 8, and the holding means 4 are relatively moved along the division line. By so doing, in addition to the previously formed deterioration zones, two deterioration zones extending continuously with the width W1 and the width W2 along the division line, or many deterioration zones of the width W1 and the width W2 located at intervals along the division line, are formed in regions displaced in the thickness direction of the workpiece 2.

In the embodiment shown in FIG. 1, the laser beam 12 is focused to the two focused spots 20 and 22, which are displaced in the direction of the optical axis, by use of the optical means 8 including the two focusing lenses 16 and 18 having different apertures. If desired, the laser beam can be focused to three or more focused spots, which are displaced in the direction of the optical axis, by use of the optical means including three or more focusing lenses having different apertures.

FIG. 2 shows a second embodiment of a machining apparatus constructed in accordance with the present invention. The machining apparatus illustrated in FIG. 2 comprises holding means 104 for holding a workpiece 102, laser beam generation means 106, and optical means 108. The holding means 104 and the laser beam generation means 106 may be of the same configuration as the holding means 4 and the laser beam generation means 6 in the embodiment shown in FIG. 1.

The optical means 108 in the embodiment shown in FIG. 2 is composed of a half mirror 124 which functions as a splitter; a mirror 126; a mirror 128; a half mirror 130; an expander 132 which functions as diameter varying means; and a common focusing lens 134. The expander 132 includes two convex lenses 136 and 138. A laser beam 112 from the laser beam generation means 106 is separated into two laser beams, i.e., a first laser beam 112a which passes through the half mirror 124 and travels straight, and a second laser beam 112b which is reflected by the half mirror 124 and travels in a changed direction, a substantially perpendicular direction. The first laser beam 112a passes through the expander 132, whereby the first laser beam 112a is turned into a form in which its diameter is varied, in more detail, its diameter is gradually increased as the first laser beam 112a goes farther away from the expander 132. Then, the first laser beam 112a passes through the half mirror 130, and is focused to a focused spot 120 within the workpiece 102 by the focusing lens 134. On the other hand, the second laser beam 112b is reflected by the mirror 126, the mirror 128 and the half mirror 130, to be thereby changed in direction to a substantially perpendicular direction upon each reflection, and to be brought into a state in which its optical axis conforms with the optical axis of the first laser beam 112a. Then, the second laser beam 112b is focused to a focused spot 122 within the workpiece 102 by the focusing lens 134. The focused spot 120 and the focused spot 122 are displaced with respect to each other in the direction of the optical axis of the first laser beam 112a and the second laser beam 112b. The position of the focused spot 120 of the first laser beam 112a can be adjusted appropriately, for example, by moving the expander 132 in the direction of the optical axis, or by moving the lens 136 or 138 of the expander 132 in the direction of the optical axis. If desired, a single convex lens may be used instead of the expander 132, and may be disposed such that the focal point of such a convex lens will come upstream of the focusing lens 134. By this measure, the laser beam can pass through the focal point of the convex lens, have its diameter gradually increased, and enter the focusing lens 134.

In the machining apparatus shown in FIG. 2 as well, deterioration zones are formed in the workpiece 102 in the vicinity of the focused spots 120 and 122, normally, in regions having certain widths, width W1 and width W2, measured upwardly from the focused spots 120 and 122. Hence, when the combination of the laser beam generation means 106 and the optical means 108, and the holding means 104 are relatively moved along a division line extending, for example, in the right-and-left direction in FIG. 2, there are formed, in the workpiece 102, two deterioration zones extending continuously with the width W1 and the width W2 along the division line, or many deterioration zones of the width W1 and the width W2 located at intervals along the division line. If the deterioration zones of the width W1 and the width W2 are not enough to divide the workpiece 102 sufficiently precisely along the division line, it is permissible to take the following measure: The combination of the laser beam generation means 106 and the optical means 108, and the holding means 104 are relatively moved by a predetermined distance in the direction of the optical axis, namely, in the up-and-down direction in FIG. 2, whereby the focused spots 120 and 122 are displaced in the direction of the optical axis, accordingly in the thickness direction of the workpiece 102. Furthermore, the combination of the laser beam generation means 106 and the optical means 108, and the holding means 104 are relatively moved along the division line. By so doing, in addition to the previously formed deterioration zones, two deterioration zones extending continuously with the width W1 and the width W2 along the division line, or many deterioration zones of the width W1 and the width W2 located at intervals along the division line, are formed in regions displaced in the thickness direction of the workpiece 102.

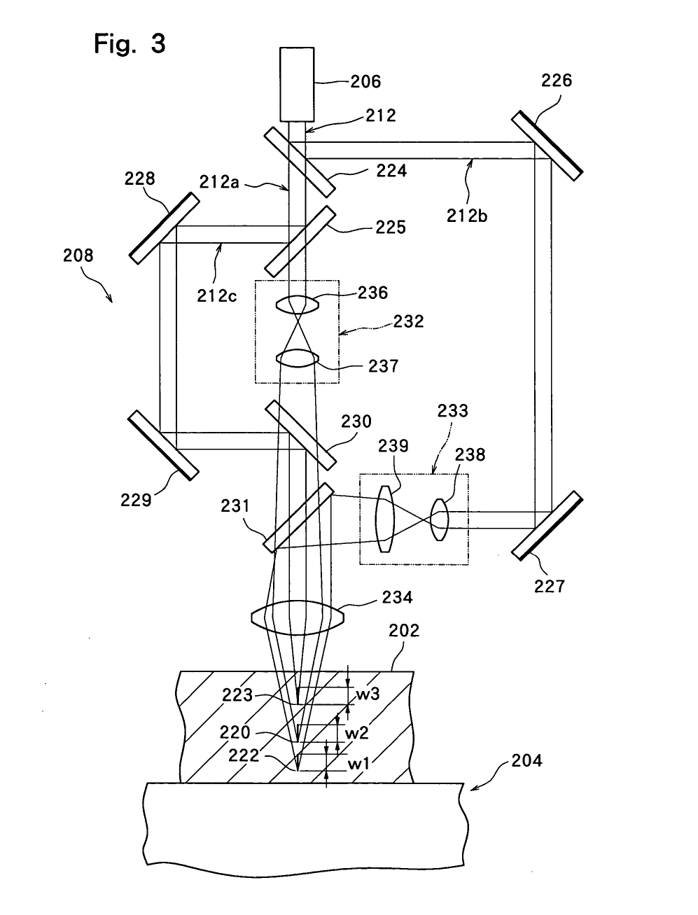

FIG. 3 shows a third embodiment of a machining apparatus constructed in accordance with the present invention. The machining apparatus illustrated in FIG. 3 comprises holding means 204 for holding a workpiece 202, laser beam generation means 206, and optical means 208. The holding means 204 and the laser beam generation means 206 may be of the same configuration as the holding means 4 and the laser beam generation means 6 in the embodiment shown in FIG. 1.

The optical means 208 in the embodiment shown in FIG. 3 is composed of a half mirror 224 which functions as a first splitter; a half mirror 225 which functions as a second splitter; a mirror 226; a mirror 227; a mirror 228; a mirror 229; a half mirror 230; a half mirror 231; an expander 232 which functions as a first diameter varying means; an expander 233 which functions as a second diameter varying means; and a common focusing lens 234. The expander 232 includes two convex lenses 236 and 237. The expander 233 also includes two convex lenses 238 and 239. A laser beam 212 from the laser beam generation means 206 is separated into two laser beams, i.e., a first laser beam 212a which passage through the half mirror 224 and travels straight, and a second laser beam 212b which is reflected by the half mirror 224 and travels in a changed direction, a substantially perpendicular direction. The first laser beam 212a passes through the half mirror 225 and proceeds afterwards. On this occasion, a third laser beam 212c, which is reflected by the half mirror 225 substantially perpendicularly, is separated from the first laser beam 212a. By passing through the expander 232, the first laser beam 212a is turned into a form in which its diameter is varied, in more detail, its diameter is gradually increased as the first laser beam 212a goes farther away from the expander 232. Then, the first laser beam 212a passes through the half mirrors 230 and 231, and is focused by the focusing lens 234 to a focused spot 220 within the workpiece 202. The second laser beam 212b is reflected by the mirror 226 and the mirror 227, to be thereby changed in direction to a substantially perpendicular direction upon each reflection, and is then passed through the expander 233. As a result, the second laser beam 212b is turned into a form in which its diameter is varied, in more detail, its diameter is gradually increased as the second laser beam 212b goes farther away from the expander 233. Then, the second laser beam 212b is reflected by the half mirror 231 to undergo a change of direction to a substantially perpendicular direction, and also to have its optical axis brought into conformity with the optical axis of the first laser beam 212a. Then, the second laser beam 212b is focused by the focusing lens 234 to a focused spot 222 within the workpiece 202. The third laser beam 212c is reflected by the mirror 228, the mirror 229 and the half mirror 230, to be thereby changed in direction to a substantially perpendicular direction upon each reflection, and to be brought into a state in which its optical axis conforms with the optical axis of the first laser beam 212a. Then, the third laser beam 212c passes through the half mirror 231, and is focused by the focusing lens 234 to a focused spot 223 within the workpiece 202. The focused spot 220, the focused spot 222, and the focused spot 223 are displaced with respect to each other in the direction of the optical axes of the first laser beam 212a, the second laser beam 212b and the third laser beam 212c. The position of the focused spot 220 of the first laser beam 212a can be adjusted appropriately, for example, by moving the expander 232 in the direction of the optical axis, or by moving the lens 236 or 237 of the expander 232 in the direction of the optical axis. Similarly, the position of the focused spot 222 of the second laser beam 212b can be adjusted appropriately, for example, by moving the expander 233 in the direction of the optical axis, or by moving the lens 238 or 239 of the expander 233 in the direction of the optical axis.

In the machining apparatus shown in FIG. 3, deterioration zones are formed in the workpiece 202 in the vicinity of the focused spots 220, 222 and 223, normally, in regions having certain widths, a width W1, a width W2 and a width W3, measured upwardly from the focused spots 220, 222 and 223. Hence, when the combination of the laser beam generation means 206 and the optical means 208, and the holding means 204 are relatively moved along a division line extending, for example, in the right-and-left direction in FIG. 3, there are formed, in the workpiece 202, three deterioration zones extending continuously with the width W1, the width W2 and the width W3 along the division line, or many deterioration zones of the width W1, the width W2 and the width W3 located at intervals along the division line. If the deterioration zones of the width W1, the width W2 and the width W3 are not enough to divide the workpiece 202 sufficiently precisely along the division line, it is permissible to take the following measure: The combination of the laser beam generation means 206 and the optical means 208, and the holding means 204 are relatively moved by a predetermined distance in the direction of the optical axis, namely, in the up-and-down direction in FIG. 3, whereby the focused spots 220, 222 and 223 are displaced in the direction of the optical axis, accordingly in the thickness direction of the workpiece 202. Furthermore, the combination of the laser beam generation means 206 and the optical means 208, and the holding means 204 are relatively moved along the division line. By so doing, in addition to the previously formed deterioration zones, three deterioration zones extending continuously with the width W1, the width W2 and the width W3 along the division line, or many deterioration zones of the width W1, the width W2 and the width W3 located at intervals along the division line are formed in regions displaced in the thickness direction of the workpiece 202.

1. A machining apparatus utilizing a laser beam, comprising:
holding means for holding a workpiece:
laser beam generation means; and
optical means for applying a laser beam from said laser beam generation means to said workpiece held by said holding means, and
wherein said optical means focuses said laser beam from said laser beam generation means to at least two focused spots displaced in a direction of an optical axis.

2. The machining apparatus according to claim 1, wherein said optical means includes at least two focusing lenses arranged in column in the direction of the optical axis and having different apertures.

3. The machining apparatus according to claim 1, wherein said optical means includes a splitter for separating said laser beam from said laser beam generation means into a first laser beam and a second laser beam; a plurality of mirrors for bringing an optical axis of said second laser beam into conformity with an optical axis of said first laser beam; diameter varying means for varying one of diameters of said first laser beam and said second laser beam; and a common focusing lens.

4. The machining apparatus according to claim 3, wherein said diameter varying means can adjust a degree to which the diameter is varied.

5. The machining apparatus according to claim 3, wherein said diameter varying means is an expander for increasing the diameter.
